(19) United States
(12) Patent Application Publication
(10) Pub. No.: US 2012/0181858 A1
(43) Pub. Date: Jul. 19, 2012

(54) INDUCTOR CONDUCTOR FOR CONTACTLESS ENERGY TRANSFER AND A USE FOR SAME IN VEHICLES

(76) Inventor: Rolf Hellinger, Hochstadt (DE)

(21) Appl. No.: 13/496,963

(22) PCT Filed: Jul. 21, 2010
(86) PCT No.: PCT/EP2010/060541

§ 371 Date: Mar. 19, 2012

(30) Foreign Application Priority Data
Sep. 18, 2009 (DE) 10 2009 042 127.0

(51) Int. Cl. H02J 17/00; B60L 1/00

(52) U.S. Cl. 307/9.1; 307/104

(57) ABSTRACT

An inductor conductor is used for the contactless transfer of electrical energy from at least one first device to at least one second device, for example from the power supply of a section of a trip route to a magnetic levitation train. The inductor conductor has a plurality of individual conductors which are arranged along a longitudinal direction. In a periodically repeating region along the longitudinal direction of the individual conductors, the individual conductors are divided into at least two parts, each part spatially separated from the other, and lie adjacent to undivided individual conductors, thus forming capacitors. In addition, a method uses the inductor conductor, for example in vehicles, wherein the inductor conductor acts as the primary winding of a transformer.

### CROSS REFERENCE TO RELATED APPLICATIONS

This application is based on and hereby claims priority to International Application No. PCT/EP2010/060541 filed on Jul. 21, 2010 and German Application No. 10 2009 042 127.0 filed on Sep. 18, 2009, the contents of which are hereby incorporated by reference.

### BACKGROUND

The present invention relates to an inductor conductor for transmitting electrical power in a contactless manner from at least one first device to at least one second device.

Electrical power for powering traction and/or auxiliary systems is transmitted in a contactless manner to vehicles in accordance with the basic principle of electromagnetic interaction. The system operates in the manner of a conventional transformer. Whereas the primary and secondary circuits are located on a common, closed ferromagnetic core in the case of a transformer, the primary winding is realized as a long conductor loop along the movement path and the secondary winding is mounted on an open ferromagnetic core which surrounds the conductor loop (“pick up”) in the case of the contactless power supply system realized today (for example Vahle CPS, or Inductive Power Supply Transrapid TR 09).

Contactless power transmission requires a magnetic field which is ensured by a current in the conductor loop of the primary part. Feeding is performed by an inverter at the highest possible frequency in order to keep the overall volume of the inductance as small as possible. In order to compensate for the inductance of the conductor loop, capacitors are connected in series at regular intervals to form a series resonant circuit. This series resonant circuit is tuned to the operating frequency, for example 20 kHz, and, at this frequency, constitutes a purely resistive load for feeding.

The discrete capacitors used lead to detuning of the resonant circuit on account of environmental conditions which are customary in the external area, on account of the temperature dependency of the capacitors and on account of aging. Furthermore, failure of the capacitors also leads to failure of the on-board power transmission system in the affected section.

### SUMMARY

One potential object of the proposed inductor conductor for transmitting electrical power in a contactless manner from at least one first device to at least one second device, is to be able to dispense with discrete capacitors for purely resistive behavior of the inductor conductor and thus to be able to increase the robustness and therefore the reliability of the inductor conductor and of a contactless power supply system which is designed using the inductor conductor, while at the same time reducing expenditure on maintenance. A further potential object of the proposed method of using the inductor conductor is to specify a simple, stable and cost-effective way of supplying power to devices in a contactless manner.

The inventor proposes an inductor conductor for transmitting electrical power in a contactless manner from at least one first device to at least one second device, which inductor conductor has a plurality of individual conductors. The individual conductors are each partly or entirely surrounded by an electrical insulator and are arranged along a longitudinal direction. At least one individual conductor is divided into at least two parts, which are physically separated from one another, in at least one first, periodically recurring region along the longitudinal direction of the individual conductors. The at least two parts are each mechanically connected to one another by an electrically non-conductive insulator bridge.

The divided parts produce capacitances which can compensate for inductances in the individual conductors. The result is a series resonant circuit which can be tuned to an operating frequency, for example 20 kHz, for example by the choice of length and by the choice of distances between divided and undivided individual conductors in one region and also by the cross-sectional areas and insulation materials of the conductors. The inductor conductor can thus constitute a purely resistive load without additional discrete capacitors having to be incorporated in the inductor conductors. This can prevent detuning of resonant circuits in the event of the aging of discrete capacitors, for example on account of environmental influences, or this effect can be delayed. Therefore, the robustness and thus the reliability of the contactless transmission of the electrical power from the at least one first device to the at least one second device is increased while at the same time reducing the expenditure on maintenance of the inductor conductor.

In order to amplify the effect, a plurality of individual conductors can be divided into in each case at least two parts, which are physically separated from one another, in the first region, and separate parts of the plurality of individual conductors can be arranged substantially parallel to at least one individual conductor, which is undivided in the first region, along the longitudinal direction. In this case, substantially parallel includes the situation of a plurality of individual conductors being stranded with one another or intertwined.

An individual conductor which is undivided in the first region can be arranged adjacent to each individual conductor which is divided into in each case at least two parts, which are physically separated from one another, in the first region. Individual conductors which are undivided in the at least one first region can be divided into at least two parts, which are physically separated from one another, in at least one second, periodically recurring region, and individual conductors which are divided into in each case at least two parts, which are physically separated from one another, in the first region can be undivided in the at least one second region. Parts, which are separated from one another, of an individual conductor in one region can form capacitors in conjunction with at least one individual conductor which is undivided in the same region.

This produces a series circuit of the inductances of the individual conductors and the capacitances across the separated parts, and the arrangement allows the discrete capacitors in electrical connection with the inductor conductor at regular intervals to be replaced or dispensed with.

The ends of the parts which are separated from one another can be rounded. The ends can, in particular, have the shape of a hemisphere. As a result, overvoltages at the ends are avoided or reduced. Overvoltages can lead to electrical breakdown and to destruction of the insulation between conductor parts. Reducing or avoiding the risk of overvoltages allows higher voltages together with lower insulation thickness of the individual conductors.

The individual conductors can comprise copper and/or aluminum or contain copper and/or aluminum. These materials provide a low non-reactive resistance in the operating state when current is flowing. The inductor conductor can be surrounded by an insulator, in particular a plastic, along the longitudinal direction. Plastic insulates the inductor conductor from the environment, protects against electric shocks and ensures long-term geometric fixing. It is a low-cost material which is easy to process and withstands environmental influences effectively over the long term.

The separated parts can have a substantially equal length a, in particular a length a in the range of from 10-100 m. The insulator bridges can likewise have a substantially equal length b, in particular a length b in the range of from 1-10 cm. The surface area of the cross section of the individual conductors can in each case be equal and/or be in the range of from 0.75 mm² to 1.5 mm². The series resonant circuit is tuned to a purely resistive behavior of the inductor conductor at an operating frequency given corresponding choice of the magnititudes. In this case, the distance and the insulation material which is located between an individual conductor which is divided in one region and an individual conductor which is undivided in the region are critical for the magnitude of the capacitance.

The inductances of the plurality of individual conductors and capacitances of the at least one capacitor can be connected in series. However, other circuit arrangements can also be realized by partial insulation of the individual conductors in relation to one another. External, discrete capacitors can also be introduced into the inductor conductor during interconnection. This can be performed, for example, for fine-tuning or in the case of variable operating frequencies.

The inductor conductor can be arranged in the form of an elongate conductor loop. As a result, the inductor conductor can act as a primary winding of a transformer in a method of using the above-described inductor conductor. Therefore, power can be transmitted in accordance with the transformer principle between the at least one first and the at least one second device if the at least one second device has a secondary winding.

A vehicle can be used as the at least one second device. The inductor conductor can be arranged along the movement path of the vehicle. As a result, it is possible to transmit electrical power between the inductor conductor, along the movement path, and to the vehicle in a contactless manner.

A stationary power supply device, in particular a stationary converter, can be used as the at least one first device.

The method can be used, for example, in a magnetic levitation system. In this case, the method is particularly robust and cost-effective since external capacitors along the movement path can be saved and therefore the capacitors are not exposed to any environmental influences either. Detuning of the resonant circuit for generating a purely resistive load of the inductor conductor is prevented by saving on external, discrete capacitors. Failure of the capacitors, and therefore, for example, failure of the on-board power supply system of a Transrapid, is avoided.

The abovementioned advantages which are associated with the proposed inductor conductor for transmitting electrical power in a contactless manner apply to the proposed method of using the above-described inductor conductor.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows an inductor conductor comprising individual conductors or conductor braids with capacitors which are connected in series according to the related art, and

FIG. 2 shows an equivalent circuit diagram of the arrangement in FIG. 1, and

FIG. 3 shows an individual conductor which is divided into two parts in conjunction with an undivided individual conductor of the proposed inductor conductor, and

FIG. 4 shows an equivalent circuit diagram of the device shown in FIG. 3, and

FIG. 5 shows a proposed inductor conductor with individual conductors which are alternately divided in a first and in a second region.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

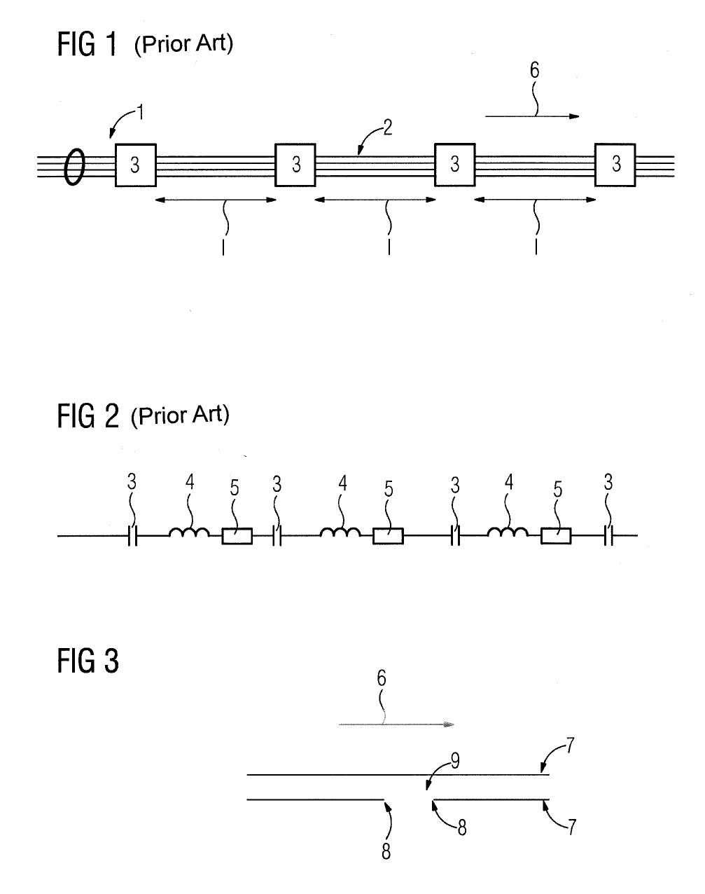

FIG. 1 illustrates an inductor conductor 1 according to the related art having discrete capacitors 3. The capacitors 3 are arranged periodically at equal distances 1 from one another and are connected to one another via an electrical line. The electrical line is made up of a plurality of conductor braids 2 in the form of individual conductors which are arranged along a longitudinal direction 6. The conductor braids 2 can be arranged parallel to one another or be stranded with one another, that is to say be arranged substantially parallel to one another. The outer circumference of the bundle of conductor braids 2, the bundle forming the electrical line, is generally surrounded by an insulator. Materials such as, for example, plastic can be used as the insulator.

The conductor braids 2 in the related art are of continuous design between the capacitors 3 and can be insulated from one another. Copper or aluminum is generally used as the material for the conductor braids 2. A braid 2 has a circular cross scion with a surface area in the region of 1 mm² or less.

FIG. 2 illustrates an equivalent circuit diagram of the inductor conductor 1 from FIG. 1. The conductor braids 2 between the discrete capacitors 3 have an inductance 4 and a non-reactive resistance 5. The capacitors 3 which are connected in series produce series resonant circuits in combination with inductances 4 and, in the case of alternating-field applications, the capacitors 3 can be selected as a function of the frequency f such that inductive 4 and capacitive resistances 3 are compensated for. The capacitively compensated inductor conductor 1 exhibits purely ohmic behavior. Therefore, the electrical losses of the inductor conductor 1 are minimized to the ohmic losses of the conductor resistances 5. However, external influences lead, over time, to aging of the discrete capacitors 3 and therefore to detuning of the resonant circuits. Additional electrical losses can thus occur.

FIG. 3 shows a detail of an inductor conductor 1. An individual conductor 7 is divided into two parts 8, with an insulator between the two parts 8. The two parts 8 are mechanically connected via the insulator, with the insulator forming a mechanical insulator bridge 9 between the two parts 8. In the event of mechanical loading of the inductor conductor 1 or in the event of stranding of individual conductors 7, this leads to a constant or substantially constant distance between the two parts 8. An individual conductor 7 which is continuous, that is to say is formed without an interruption or gaps in the conductor, in the region of the insulator bridge 9 of the two parts 8 is arranged parallel or substantially parallel, for example when the individual conductors 7 are stranded with one another or are interweaved, to the two parts 8 of an individual conductor 7.

The individual conductors 7 and separated parts 8 of an individual conductor 7 are each surrounded by an insulator at their circumference, the insulator generally comprising plastic and being formed with a thickness or wall thickness in the region of 1 mm and less. The plastic is, for example, in the form of a tube which closely surrounds a copper or aluminum cable. The cable generally has a circular cross section with a cross-sectional surface area in the range of from 0.75 mm² to 1.5 mm². The ends of the parts 8 are rounded, for example they may have the shape of a hemisphere. As a result, overvoltages are avoided at the ends. The ends of the parts 8 are electrically insulated by the insulator bridge 9 or can likewise be completely covered by a plastic layer and/or the plastic tube. The insulator (plastic) forms the dielectric of the capacitors 10.

In the region illustrated in FIG. 3, the parts 8 and the continuous individual conductor 7 are at a distance from one another, this distance depending on the thickness of the insulator around the individual conductors 7 or parts 8 of the individual conductors 7. The distance is generally equal to twice the thickness of the insulator around an individual conductor 7 or parts 8 of an individual conductor 7. This distance is much shorter than the length of the insulator bridge 9. Therefore, in each case one end of a part 8 of an individual conductor 7, in conjunction with the adjacent continuous individual conductor 7 in the shown region, acts as a capacitor.

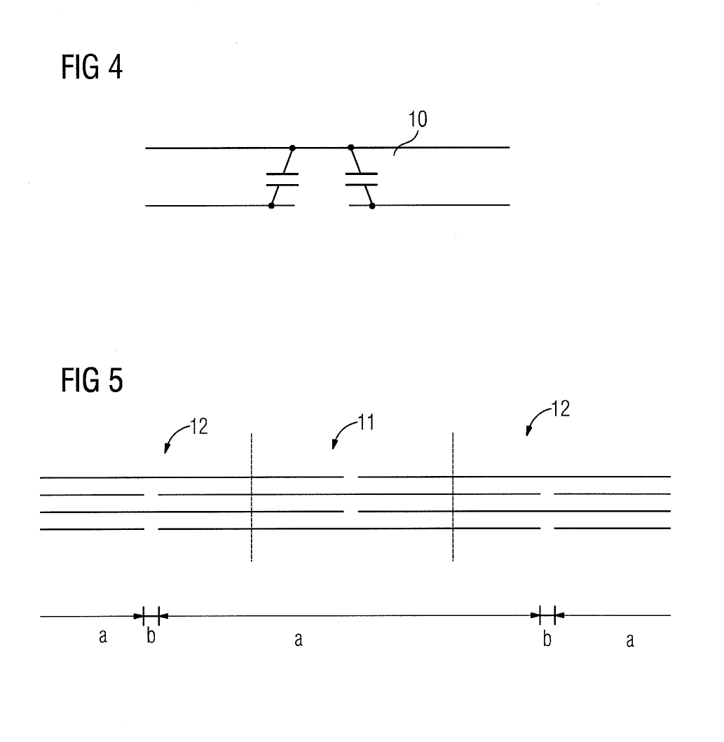

FIG. 4 illustrates an equivalent circuit diagram of the detail of the inductor conductor 1 shown in FIG. 3. The two ends, which are shown in FIG. 3, of the individual conductor parts 8 are capacitively coupled by the adjacent, continuous individual conductor 7. The capacitance of the parts 8, which are physically separated from one another and are mechanically connected to one another by the insulator bridge 9 and are fixed in terms of distance, is determined, inter alia, by the insulator material and by the distance between the individual conductor 7 which is continuous in the region and in each case one part 8 of the separated individual conductor 7.

FIG. 5 illustrates an exemplary embodiment of the arrangement of the individual conductors 7, which are shown in FIG. 3, in an inductor conductor 1. In this case, the length a of a part 8 of an individual conductor 7 can be in the region of a few 10 m. The length b of the insulator bridge or of the distance between two parts 8 can be in the region of a few centimeters, in particular 1 cm. The inductor conductor 1 is made up of two periodically alternating regions 11 and 12.

A row of individual conductors 7, which are continuous in the region, and parts 8 of individual conductors 7 are arranged in a region 11 or 12, analogously to the pair of continuous individual conductors 7 and individual conductor parts 8 shown by way of example in FIG. 3. The divided individual conductors 7 are of continuous design in the adjoining region 12 or 11, and the individual conductors 7 which are of continuous design are divided in the region 11 or 12. Regions 11 and 12 each alternate and have the same length; as a result, all the individual conductors 7 are divided in the region 11 or 12 and are respectively undivided in the other region 12 or 11. The entire system of individual conductors 7 can be stranded with one another, with the insulator bridges 9 making stranding possible in the first instance and ensuring an equal distance between in each case two parts 8 during the stranding process. Since all the individual conductors 7 in the inductor conductor 1 are divided or have an electrically insulating bridge 9 in a region 11 or 12, the inductor conductor 1 acts like an inductor conductor 1 with capacitors which are connected in series.

As shown in FIG. 5, it is advantageous when the insulator bridges 9 in a region 11, 12 are in each case all arranged at one point along the longitudinal direction 6. The effective distance between “capacitors” in the inductor conductor 1 then corresponds in each case to the distance between the point in the region 11 and the point in the region 12; in fact the capacitors are formed along the entire length by the conductor groups which run in parallel. As shown in FIG. 5, this distance can correspond to half the sum a+b or, on account of the much higher value of a, substantially to the length a/2 in the case of a periodic design. The result is a series circuit of resonant circuits formed by capacitances 10 of the physically separated parts 8 connected by the individual conductors 7 which are each continuous in a region 11, 12, and by inductances and non-reactive resistances of the individual conductors 7 or parts 8. Given suitable selection of the cross section and material of the individual conductors 7 and the insulation of the individual conductors, and by suitable selection of the lengths of the parts 8 and geometries of the ends and also of the insulator bridges 9, the resonant circuits can be adjusted such that capacitive and inductive components cancel each other out and the inductor conductor 1 as a whole exhibits a purely ohmic loss. Discrete capacitors 3 can be saved and therefore detuning of the resonant circuit due to aging of the discrete capacitors 3 on account of environmental influences can be prevented.

The inductor conductor 1 or two inductor conductors 1 (forward and return conductors) can be arranged along a movement path of a vehicle in the form of a conductor loop with an extension in length along a direction of movement. In this case, the inductor conductor 1 forms a primary coil which is arranged in the plane of the movement path. The inductor conductor 1 can be electrically connected to a first device which delivers electrical power. Therefore, for example, one or more power stations, rechargeable batteries, solar cells, wind-power systems or other energy-generating or energy-storing devices can be electrically connected to the inductor conductor 1 by a converter for converting the frequency to the resonant frequency of the inductor conductor 1, and supply power to the inductor conductors. This power can be transmitted in a contactless manner to a second device, for example a vehicle, by magnetic fields and induction. Therefore, for example, a magnetic levitation system can be supplied with power, in particular for driving and control purposes, by the inductor conductor 1 when the inductor conductor 1 is accommodated in the movement path of the magnetic levitation system and the magnetic levitation system moves along the movement path. In this case, a plurality of inductor conductors 1 can also be used, it being possible for conductor loops to be arranged in an “interengaging manner”. In this case, discrete compensation capacitors 3 can be dispensed with since the capacitance 10 of the parts 8, which are separated in one region, of the individual conductors 7, in conjunction with adjacent individual conductors 7 which are continuous in the region, can compensate for inductances 4 of the individual conductors 7. The only electrical loss in the no-load state, with the load being produced, for example, by a vehicle drawing power, is the non-reactive resistance of the inductor conductor 1 and any eddy-current losses which may occur in the surrounding area, for example in the steel reinforcement.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide V. DIRECTV, 69 USPQ2d 1865 (Fed. Cir. 2004).

1-16. (canceled)

17. A first device for transmitting electrical power in a contactless manner to a second device, comprising:
an inductor conductor having a plurality of individual conductors which are each at least partly surrounded by an electrical insulator, the individual inductors being arranged along a longitudinal direction, the inductor conductor having periodically recurring first regions along the longitudinal direction, within each first region at least one individual conductor is divided into at least two parts, which are physically separated from one another.

18. The first device as claimed in claim 17, wherein the at least two parts of the at least one individual conductor are each mechanically connected to one another by an electrically non-conductive insulator bridge.

9. The first device as claimed in claim 17, wherein within each first region, the inductor conductor comprises:
an undivided individual conductor; and
a plurality of separated individual conductors each divided into at least two parts, which are physically separated from one another, the parts of the plurality of separated individual conductors being arranged substantially parallel to one another along the longitudinal direction and substantially parallel to the undivided individual conductor.

20. The first device as claimed in claim 17, wherein within each first region, the inductor conductor comprises:
an undivided individual conductor; and
at least one separated individual conductor, which is divided into at least two parts, which are physically separated from one another, the at least two parts being arranged adjacent to the undivided individual conductor.

21. The first device as claimed in claim 20, wherein
the plurality of individual conductors comprise a first individual conductor and a second individual conductor,
the inductor conductor has at least one second region between two adjacent first regions,
the first individual conductor is divided in the first regions into at least two parts, which are physically separated from one another,
the first individual conductor is undivided in the least one second region,
the second individual conductor is divided in the at least one second region into at least two parts, which are physically separated from one another, and
the second individual conductor is undivided in the first regions.

22. The first device as claimed in claim 19, wherein a capacitor is formed between the undivided individual conductor and each part of the at least two parts, which are separated from one another.

23. The first device as claimed in claim 22, wherein
the plurality of individual conductors have respective inductances, and
the inductances of the plurality of individual conductors and the capacitors are connected in series.

24. The first device as claimed in claim 17, wherein the at least two parts, which are separated from one another have rounded ends with a hemisphere shape.

25. The first device as claimed in claim 17, wherein the plurality of individual conductors are stranded and/or intertwined.

26. The first device as claimed in claim 17, wherein the individual conductors comprise copper and/or aluminum.

27. The first device as claimed in claim 17, wherein the individual conductors of the inductor conductor are together surrounded by an outer insulator at an outer circumference of the indictor conductor, along the longitudinal direction.

28. The first device as claimed in claim 27, wherein the outer insulator comprises a glass reinforced plastic, formed as a dimensionally stable bandage.

29. The first device as claimed in claim 18, wherein
the at least two parts, which are physically separated from one another, have a substantially equal length a, and/or
each insulator bridge has a substantially equal length b, and/or
the individual conductors have a substantially equal cross-sectional surface area.

30. The first device as claimed in claim 17, wherein the inductor conductor is formed as an elongate conductor loop.

31. A method of transmitting electrical power in a contactless manner to a second device, comprising:
using an inductor conductor as a primary winding of a transformer, the inductor conductor having a plurality of individual conductors which are each at least partly surrounded by an electrical insulator, the individual inductors being arranged along a longitudinal direction, the inductor conductor having periodically recurring first regions along the longitudinal direction, within each first region at least one individual conductor is divided into at least two parts, which are physically separated from one another.

32. The method as claimed in claim 31, wherein
the second device is a magnetic levitation vehicle, and/or
a stationary power supply device is surrounded by the indictor conductor.

33. The method as claimed in claim 32, wherein
the longitudinal direction corresponds to a movement path of the vehicle such that the inductor conductor is arranged along the movement path of the vehicle, and
electrical power is transmitted in a contactless manner between the inductor conductor and the vehicle.
